(19) United States
(12) Patent Application Publication
(10) Pub. No.: US 2017/0354156 A1
(43) Pub. Date: Dec. 14, 2017

(54) Apparatus, System, and Process for Making a Bakery Product

(71) Applicant: Stewart Systems Baking, LLC, Plano, TX (US)

(72) Inventor: Augusto Florindez, Plano, TX (US)

(21) Appl. No.: 15/688,220

(22) Filed: Aug. 28, 2017

Related U.S. Application Data
(63) Continuation-in-part of application No. 13/938,492, filed on Jul. 10, 2013, now Pat. No. 9,763,455.

(51) Int. Cl. A21C 1/14; A21C 9/04; A21C 14/00; A21C 1/00; A21C 1/04

(52) U.S. Cl. CPC A21C 1/141; A21C 9/04; A21C 1/146; A21C 14/00; A21C 1/149; A21C 1/04; A21C 1/006

(57) ABSTRACT

A system to make a bread loaf includes means for moving continuously pans along a predetermined path, each pan including at least one cavity sized and configured for making a bread loaf. Means conditioning continuously a batch of unconditioned dough reduces the size of air pockets therein to form a conditioned dough. Means continuously extrude the batch of conditioned dough at a controlled volumetric feed rate and at a controlled pressure to provide a constant stream of conditioned dough that is continuously cut into individual packets. The entire batch is converted into individual packets of conditioned dough corresponding to a predetermined number of bread loaves to be produced from the batch, with all the packets deposited individually in cavities of the pans.

### CROSS-REFERENCE TO RELATED APPLICATION

This application is a continuation-in-part and claims the benefit under 35 U.S.C. §119(e) of U.S. Non-Provisional patent application Ser. No. 13/938,492 filed on Jul. 10, 2013, entitled “Apparatus, System and Process for Making a Bakery Product,” which is incorporated by reference in its entirety.

### FIELD OF THE DISCLOSURE

The present disclosure generally relates to making a bakery product.

### BACKGROUND

When making bakery products, and in particular, bread loaves, two different types of dough mixes are employed: a conventional batch mix and a continuous mix. The mix used in a conventional batch process provides a stiff dough that, on baking, produces a bread loaf having a firm texture that many consumers find highly desirable. An example of a conventional batch mix baked loaf of bread, is sold by Bimbo Bakeries USA, Inc. under the brand name Orowheat and others. A problem with any type of bread dough either continuous dough mix or conventional batch mix is that, after mixing of the ingredients called for by the mix's recipe, air pockets of different sizes are formed by the chemical reaction of the yeast, sugar, flour and other ingredients. As the dough is transferred from a mixer it ages and the dough starts to generate at the beginning small air pockets, but as the dough ages, the small air pockets become enlarged and different sized air pockets form, requiring conditioning.

In the batch process, the air pockets are reduced in size and rendered highly uniform in size by processing the dough using numerous pieces of equipment and processing steps as depicted in FIGS. 2, 2A and 2B, and discussed subsequently in greater detail. A dough developer unit is used in the continuous process to render the air pockets uniform; however, this produces a soft dough. But this soft dough, on baking, produces a bread loaf having a soft, spongy texture.

### SUMMARY

In brief, the apparatus, system, and process using a conventional batch process dough mix produces a stiff dough that, on baking, produces a bread loaf having a firm texture that many consumers find highly desirable. The apparatus, system, and process eliminate most of the equipment and process steps required using known equipment and process steps to make a bread loaf having a firm texture using a conventional batch mix.

The apparatus, system and process for making bakery products has one or more of the features depicted in the embodiment discussed in the section entitled DETAILED DESCRIPTION. The claims that follow define the apparatus, system and process, distinguishing them from the prior art; however, without limiting the scope of the apparatus, system and process as expressed by these claims, in general terms, some, but not necessarily all, of their features are:

One, the apparatus for making bread loaves includes a mixer in which ingredients to make a batch of bread dough are mixed. This batch provides a predetermined number of bread loaves. The apparatus converts the entire batch into individual packets of conditioned dough corresponding to the predetermined number of bread loaves to be produced from the batch. The individual packets are deposited individually directly in cavities of the pans within from 10 to 20 minutes after mixing the ingredients to portion the batch without flour dust and without additional processing of the dough prior to deposition in a pan cavity.

Two, a pan feeder continuously moves baking pans in a stepwise manner along a predetermined linear path, with each pan having at least one empty cavity sized and configured to bake a single bread loaf. The pan feeder includes a pair of aligned pan conveyors along the predetermined linear path along which the pans move that are spaced apart to provide a gap beneath the extrusion port to facilitate flushing waste matter from the apparatus during cleaning.

Three, a dough developer unit above the predetermined linear path reduces the size of air pockets within unconditioned dough, so that dough exiting the developer unit is conditioned.

Four, a first transfer pump continuously feeds the unconditioned dough from a holding hopper to the dough developer unit, and an extrusion unit below the dough developer unit and above the predetermined linear path continuously extrudes the conditioned dough into a dough stream. A second transfer pump continuously meters the conditioned dough from the extrusion unit through an extrusion port of a die manifold member of the extrusion unit. The extrusion port is in a face of a die manifold member from which the dough stream exits.

Five, a cutter unit above the predetermined linear path continuously cuts the dough stream into individual packets, a single packet to be deposited in an individual cavity in a pan moving along the predetermined path. The cutter unit includes a blade that moves through a predetermined closed path from a home position above the dough stream, along the face of the die manifold member past the extrusion port to sever the dough stream, and then away from the face of the die manifold in a manner to avoid interfering with the dough stream from continuing to exit unencumbered from the extrusion port. The blade is moved from a home position above the dough stream along a downward vertical-linear path at a first rate of speed and, after moving away from the face of the die manifold, is moved at an increased rate of speed to the home position at least in part along an upward vertical-linear path.

Six, the extrusion port is positioned relative to the predetermined linear path so that, upon cutting the dough stream, the single packet drops directly into a cavity of a pan positioned directly beneath the extrusion port. The extrusion port has a rectangular shape with opposed sides, each side comprising a laterally adjustable wedge-like slide element to enable the width of the extrusion port to be changed. The die manifold member includes a chamber having a generally flat top and flat bottom and outward sloping sides to form a generally shaped triangle configuration. There is an entry end at an apex of the triangular configuration and the extrusion port forms the base of the triangular configuration.

Seven, a control system delivers the dough stream to the cutter unit at a controlled volumetric feed rate and at a controlled pressure. The control system includes a monitoring element that senses the amount of conditioned dough being produced and, in response thereto, regulates the operation of the dough developer unit. The control system includes a pressure sensor that detects the pressure of the dough stream and a microprocessor programmed to operate speed controls as a function of the pressure.

The process of making a bread loaf from a conventional batch dough mix includes the following steps:

(a) continuously moving pans along a predetermined path, each pan including at least one cavity sized and configured for making a bread loaf,

(b) continuously conditioning a batch of unconditioned dough to reduce the size of air pockets within the unconditioned dough and so produce a conditioned dough,

(c) continuously extruding the batch of conditioned dough at a controlled volumetric feed rate and at a controlled pressure to provide a constant stream of conditioned dough,

(d) continuously cutting the stream of conditioned dough into individual packets, a single packet being directly deposited in an individual cavity of a pan moving along the predetermined path without additional processing of the dough prior to deposition in the cavity.

The batch makes a predetermined number of packets and the process is completed for the batch within a predetermined time period so that a last packet of the batch and a first packet of the batch have the same uniform density and uniform texture. The entire batch is converted into individual packets of conditioned dough corresponding to the predetermined number of bread loaves to be produced from the batch. The packets are deposited individually in cavities of the pans within from 10 to 20 minutes after mixing ingredients that make the batch. Upon formation of a packet, the packet drops due to gravity directly into a cavity of a pan without further processing of the packet after cutting the dough stream to form the packet. The dough stream is processed without the use of flour to treat the dough stream.

These features are not listed in any rank order nor is this list intended to be exhaustive. Other technical features may be readily apparent to one skilled in the art from the following figures, descriptions and claims.

### BRIEF DESCRIPTION OF THE DRAWINGS

For a more complete understanding of this disclosure, reference is now made to the following description, taken in conjunction with the accompanying drawings, in which:

FIG. 1 depicts a schematic diagram illustrating a prior art continuous bread dough mixing system;

FIG. 2 depicts a schematic diagram illustrating a conventional batch bread dough mixing system;

FIG. 2A depicts a side elevation view a bread loaf manufacturing line employing the prior art batch bread dough mixing system illustrated in FIG. 2;

FIG. 2B depicts a top plan view a bread loaf manufacturing line shown in FIG. 2A;

FIG. 3 depicts a schematic diagram illustrating the process for making a bakery product according to an embodiment of the present disclosure;

FIG. 4 depicts a front elevation view of the apparatus, with sections broken away according to an embodiment of the present disclosure;

FIG. 5 depicts a side elevation view of the apparatus, with sections broken away according to an embodiment of the present disclosure;

FIG. 6 depicts a top plan view of the extrusion divider unit of the apparatus illustrated in FIGS. 4 and 5 according to an embodiment of the present disclosure;

FIG. 7 depicts a top plan view of the developer unit of the apparatus illustrated in FIGS. 4 and 5, with sections broken away according to an embodiment of the present disclosure;

FIG. 8A depicts a side elevation view of a cutter of the dough divider unit positioned above the extrusion unit, which is above a series of empty pans moving beneath the extrusion unit according to an embodiment of the present disclosure;

FIG. 8B depicts a cross-sectional view taken along line 8B-8B of FIG. 8A according to an embodiment of the present disclosure;

FIG. 8C depicts a diagram of a predetermined closed path the tip of a knife blade makes through one cycle of the cutter according to an embodiment of the present disclosure;

FIG. 8D depicts a sectional view taken along line 8D-8D of FIG. 8A according to an embodiment of the present disclosure;

FIG. 9 depicts a front elevation view of the cutter positioned to cut the dough stream from the extrusion unit according to an embodiment of the present disclosure;

FIG. 10A depicts a side elevation view with the cutter in its home position according to an embodiment of the present disclosure;

FIG. 10B depicts a side elevation view with the cutter in its down position according to an embodiment of the present disclosure;

FIG. 10C depicts a side elevation view showing starting to return to the home position according to an embodiment of the present disclosure; and

FIG. 11 depicts a control circuit diagram for the apparatus according to an embodiment of the present disclosure.

### DETAILED DESCRIPTION

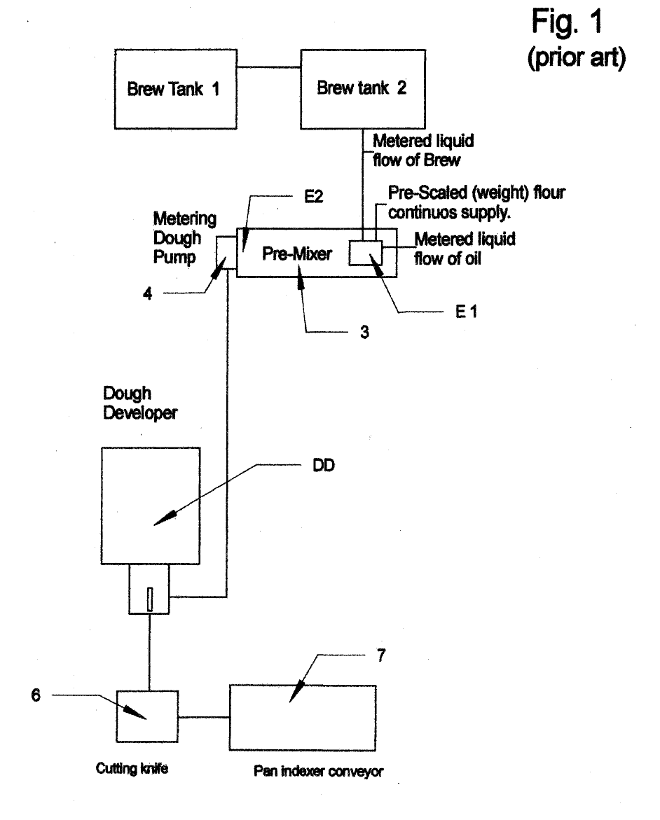

FIG. 1 depicts a continuous process (known as DO-Maker, Wallas and Thierman System) for making loaves of bread. In tank 1 mixing is conducted of all the basic ingredients to start a brew batch of a selected dough recipe, for example, to make whole-wheat, white, or multi-grain loaves of bread. The ingredients of this initial batch begin to ferment in tank 1. While in a highly fluid liquid state, the entire contents of tank 1 are pumped into tank 2. Tank 2 is a holding tank for the fermenting phase of the mixture of ingredients that is continuously transferred to a pre-mixer 3. The fluid from tank 2 is metered as it is fed to pre-mixer 3, and metered amounts of flour and oil are continuously added as this fluid flows into pre-mixer 3. Pre-mixer 3 has at its intake end E1 two (2) shaft agitators (not shown) constructed with radial flat narrow blades (not shown) at the intake E1.

At its discharge end E2, the agitators become dual augers (not shown) rotating away from each other, one clockwise and the other counterclockwise. The fluid from tank 2 is in a liquid state as it enters intake end E1, being a soft and watery viscous mix. As this mix exits tank 2 flour and shortening (oil) are added at the intake E1, all these ingredients are mixed at the same time continuously to become a very soft dough including air pockets that exits discharge end E2. The dough exits pre-mixer 3 in a constant and evenly pressurized continuous flow of dough to metering dough pump 4 that forwards this viscous dough to a dough developer unit DD. In dough developer unit DD, the dough is given its final mix and conditioning by kneading the viscous dough to render it of uniform density and uniform texture. Metering dough pump 4 pumps the metered dough as a continuous stream that is cut by guillotine type dual knife cutter 6. The severed pieces individually drop into pans P being moved by indexer pan feeder 7 along a linear path in a stepwise manner.

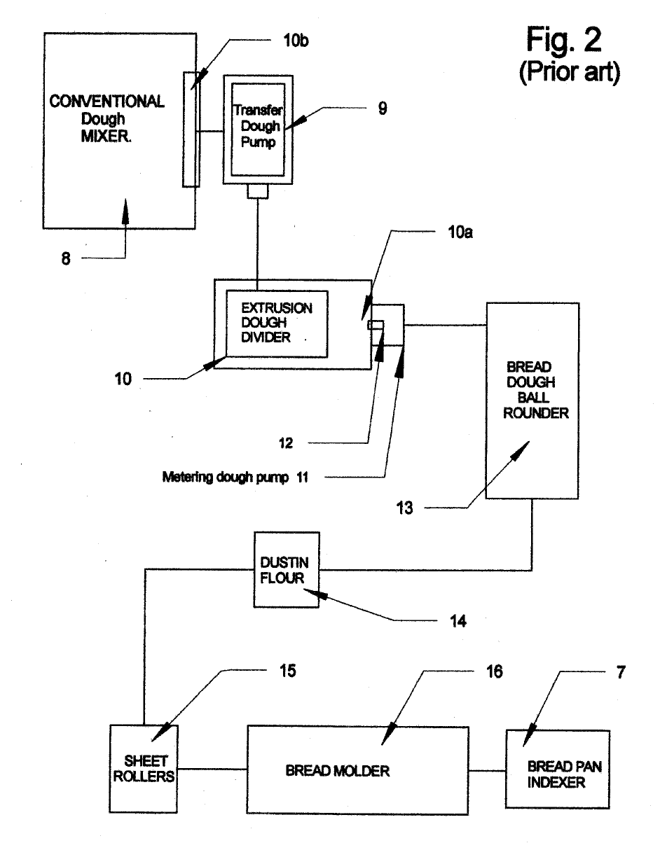

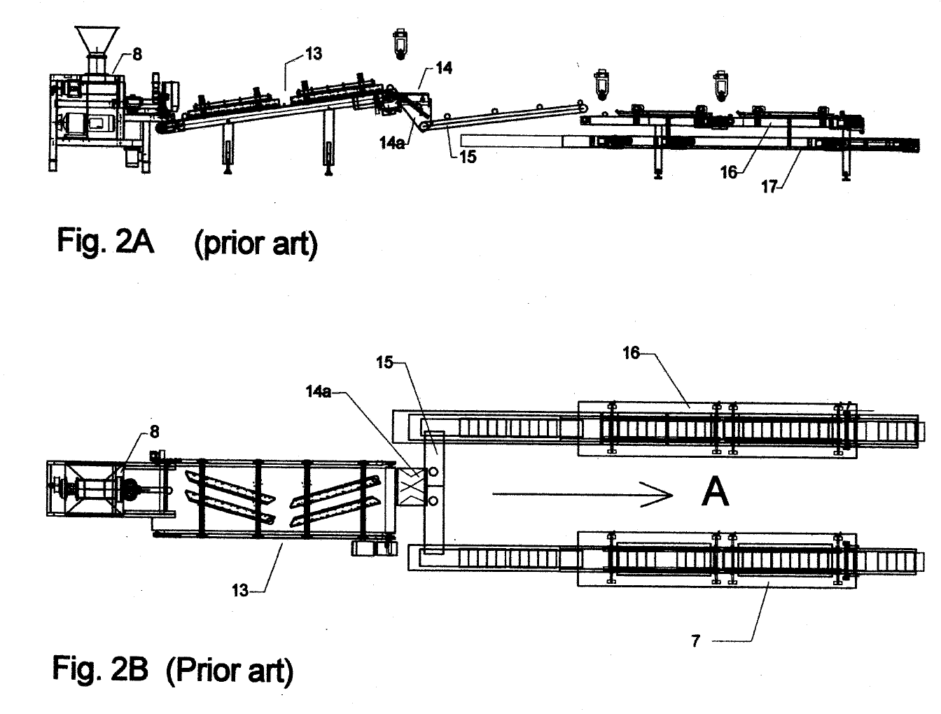

FIGS. 2, 2A and 2B depict a conventional batch process for making loaves of bread. When employing the prior art process illustrated in FIG. 2, extensive floor spaced and equipment is required as shown in FIGS. 2A and 2B. This space and equipment is costly and demands maintenance.

In this batch process the ingredients for a selected bread recipe are mixed in conventional dough mixer 8, which may have a temperature control system that maintains the temperature of the ingredients in the mixer at about 68 degrees Fahrenheit. When the ingredients are thoroughly mixed and in a viscous state, the whole batch of dough mix is dumped into the holding dough hopper of transfer dough pump 9, transfers the dough to extrusion dough divider hopper 10c and into extrusion dough divider EDD. Extrusion dough divider EDD is built with a gear motor drive, and a dual auger feeder, and acts as a pump to pressurize the dough to a pre-set pressure value of a process recipe, set in a programmable logic controller (PLC) at a human-machine interface (HMI). In response to dough pressure sensor 12 located at a discharge end of extrusion dough divider EDD, the gear motor drive will speed up or slow down the auger rotational speed to satisfy the pressure set point value set in the recipe required pressure value. Metering dough pump 11 meters a constant volumetric dough flow at exit 10a of extrusion dough divider EDD. The rate of speed of the pump drive controls the rate and scaling-weight at which severed dough packets SDP are produced. The speed required of the dough metering pump gear motor drive is monitored by a human operator manually checking at pre-scheduled times (every 2 minutes or so) the weight of a sampled dough packet being cut by an extrusion dough divider guillotine-type knife.

Severed dough packets SDP require further processing. Namely, first severed dough packets SDP are rounded into dough balls by rounder unit 13. The newly rounded dough balls are flour-dusted in duster 14 to prevent the dough balls from sticking to any surfaces while they are transported by conveyor belt 14a to sheet unit 15 to make the newly flour dusted dough balls into a very flat disk-like member. From sheet unit 15, the dough disk-like members are conveyed to molder belt unit 16, where, with the aid of static top pressure board adjustable up or down rolls, the dough disk like members are formed into individual cylindrical shape dough pieces, before they are deposited into an empty pan cavity. Bread pan indexer 7 synchronizes the deposit of the cylindrical shape dough pieces so an individual piece falls into a single pan cavity.

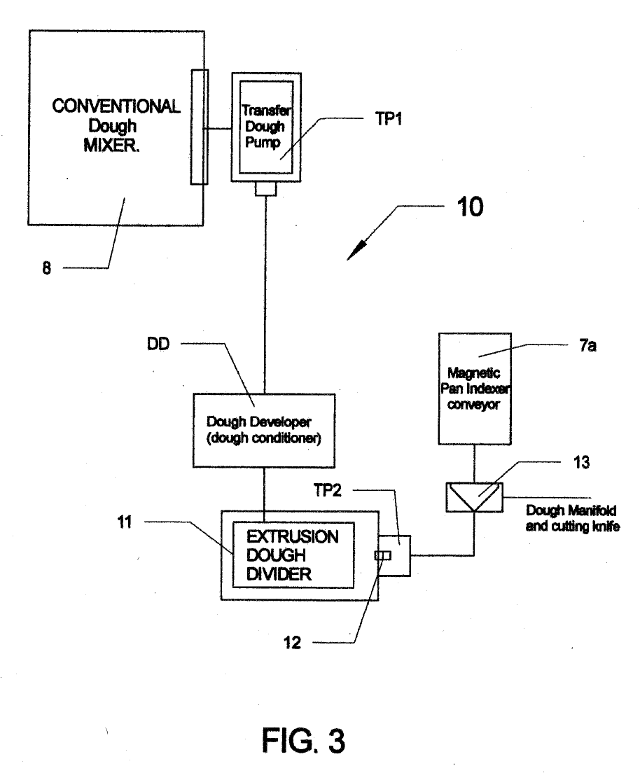

As illustrated in FIG. 3, the process has the advantage of a batch process in that the dough mix used produces the desired stiff texture bread loaf and the advantage of a continuous process that avoids the downstream processing steps and equipment depicted in FIGS. 2A and 2B. Initially, all the ingredients of a conventional batch mix recipe to make a batch of bread dough are mixed in conventional mixer 8 to produce a conventional dough mix, which is significantly more viscous than the dough mix from pre-mixer 3 using a standard recipe in a continuous mix process. At first, this mix has therein small sized air pockets that become larger and different sized air pockets as the fresh dough mix ages. The air pockets are produced by the chemical reaction of yeast, sugar, flour and other ingredients. A single batch provides a predetermined number of bread loaves, for example, from about 1,400 to about 2,000 loaves per batch.

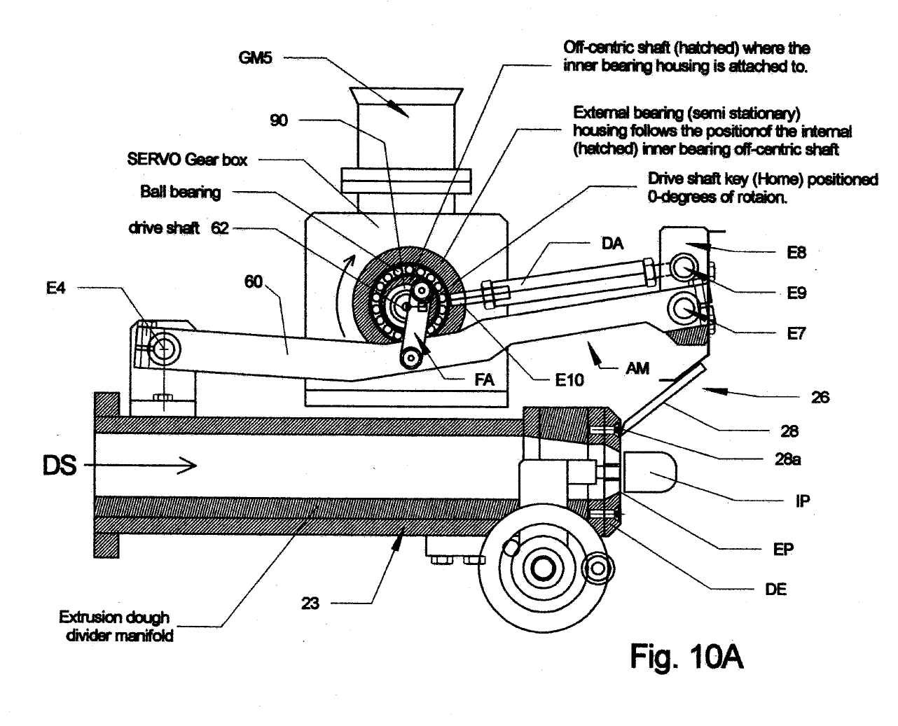

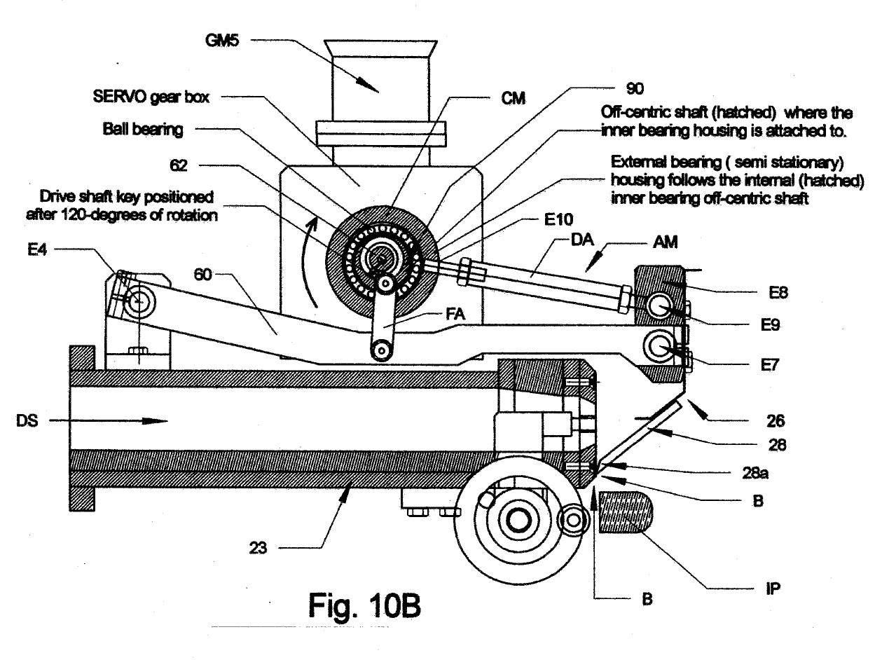

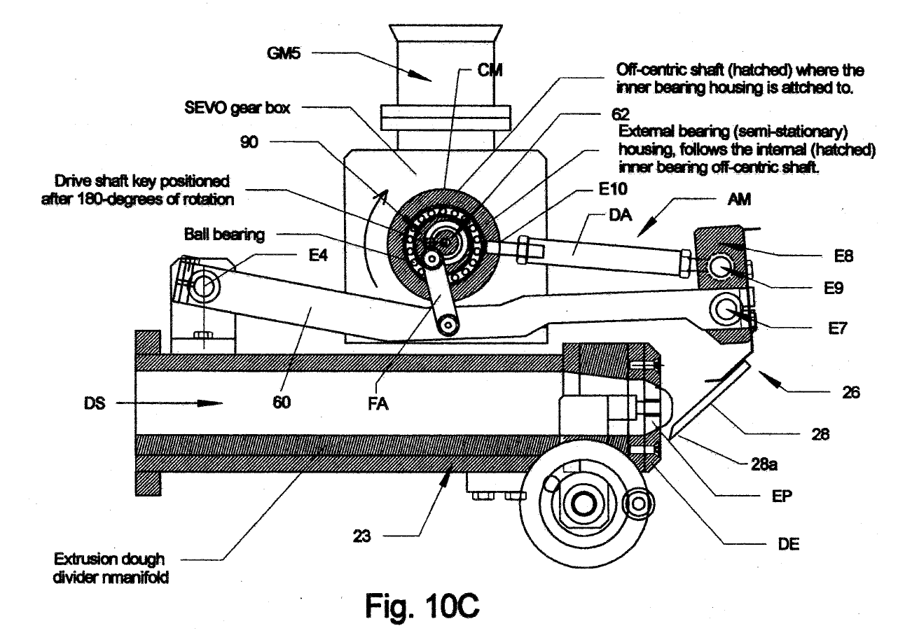

As soon as the ingredients have been thoroughly blended together and the reaction starts, a first transfer pump TPI immediately, continuously and directly feeds the unconditioned dough from mixer 8 into conventional dough developer unit DD. The now-conditioned dough flows directly into extrusion dough unit 11 having unique die manifold member 23 that is designed especially for high-speed production of pan-ready dough packets. The pan-ready dough packets made according to the process fall directly into a pan cavity upon being severed from a continuous dough stream by uniquely designed cutter 26 best illustrated in FIGS. 10A through 10C. Thus, the process eliminates the downstream processing steps and equipment of the conventional batch process depicted in FIGS. 2, 2A and 2B.

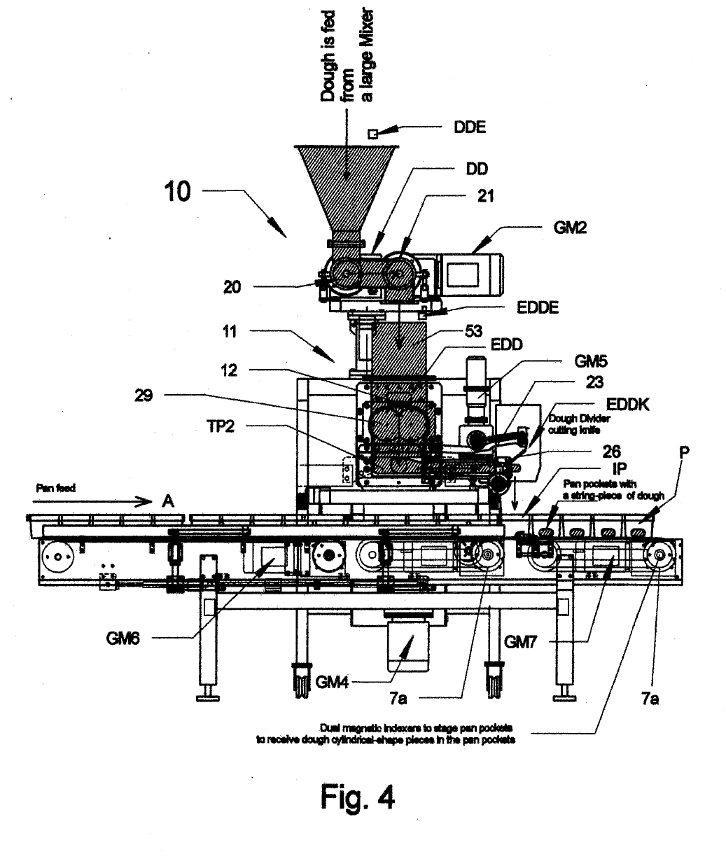

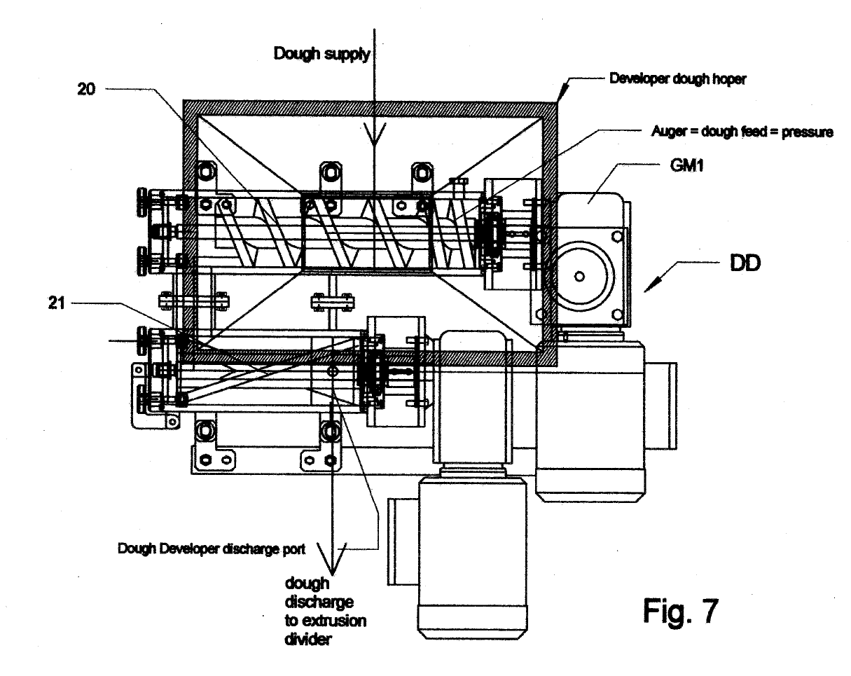

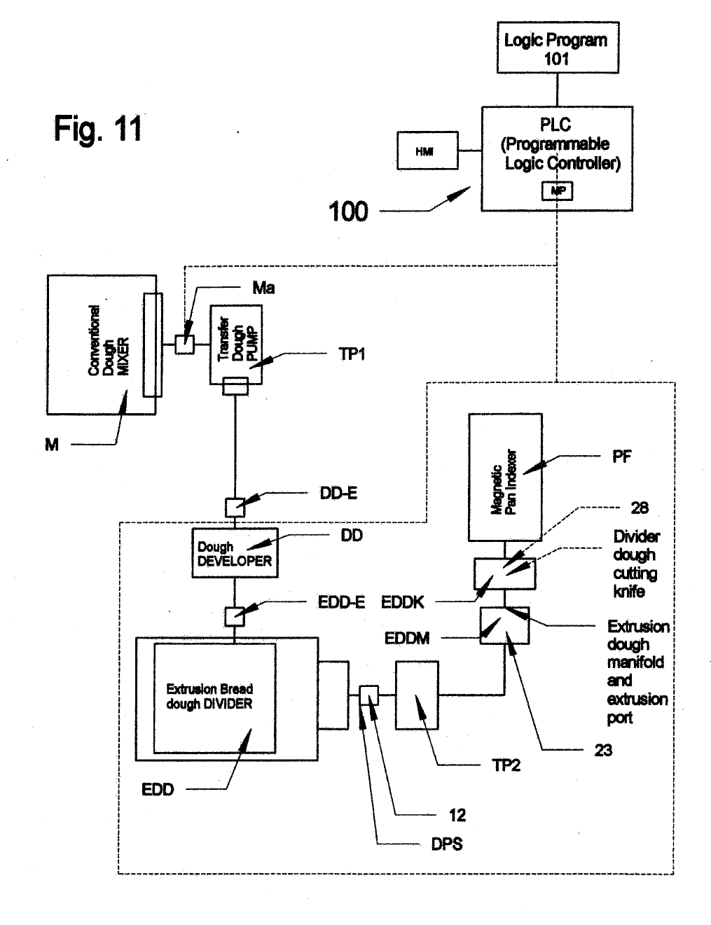

Conventional dough developer unit DD continuously conditions the batch of unconditioned dough to reduce the size of air pockets within the unconditioned dough. Ideally, the conditioned dough has a uniform density and a uniform texture as it exits dough developer unit DD that is maintained more or less constant throughout the entire processing of a batch of the dough mix. Dough developer unit DD (FIGS. 4, 5, 7) has gear motor GM1 that drives single auger 20, and gear motor GM2 that drives developer blade 21. Developer gear motors GM1 and GM2 drive speeds (recipe speeds) may be manually or automatically set. In the former case, gear motors GM1 and GM2 drive speeds are monitored by a human operator who manually changes the set speeds at human-machine interface control panel HMI as required by the process recipe. Alternately, to maintain a constant uniform density and uniform texture of the dough, dough developer auger 20 and developer blade 21 rotational speeds will be increased or decreased according to an electronic speed control logic sequence in main control process programmable logic controller PLC (FIG. 11). A sub-routine of program 101 of microprocessor MP of control circuit 100 provides automatic speed control to maintain a uniform density and uniform texture of the dough stream exiting dough developer unit DD. Thus, a conditioned dough is continuously fed to extrusion dough divider unit 11 at various speeds to maintain a uniform density and uniform texture.

In the process, conventional dough developer unit DD transforms large size air pockets within the unconditioned dough, dividing the larger air pockets into smaller size air pockets, so that dough exiting developer unit DD is conditioned with a uniform density and uniform texture. This achieves a uniform product quality and a uniform scaling. Consequently, in the process, a human operator does not periodically sample and weigh the dough packets to insure the individual bread loaves being made do not vary more than quality standards demand. Using dough developer unit DD, upon formation of a packet, the packet drops, due to gravity, directly into cavity C of pan P without further processing of the packet after cutting the dough stream to form the packet as shown in FIGS. 10A-10C, and discussed subsequently in greater detail.

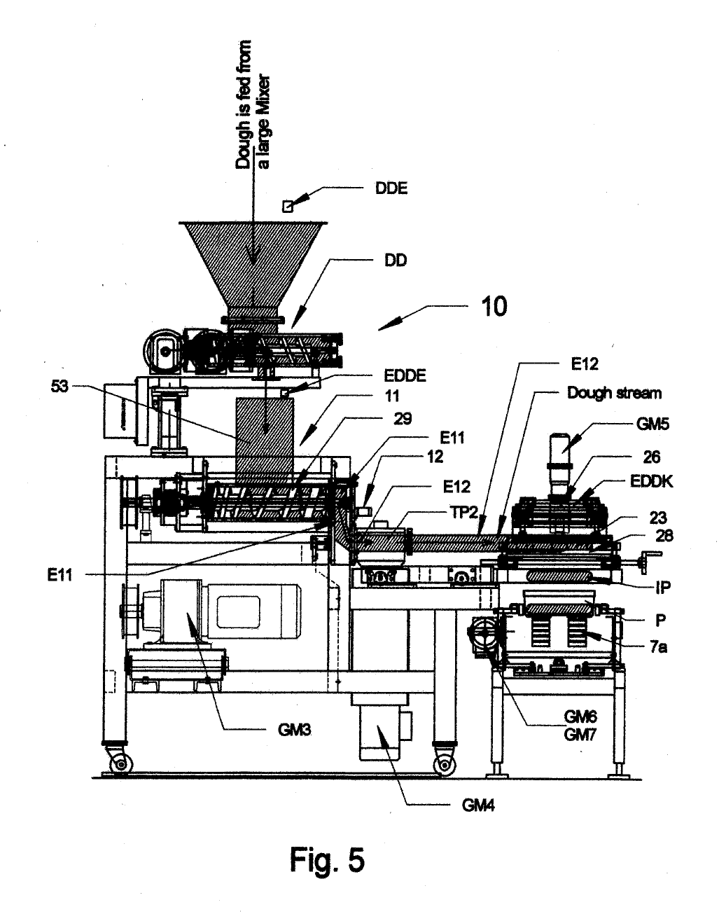

As illustrated in FIGS. 4 and 5, one embodiment of the apparatus embodying the system is generally designated by the numeral 10. The movement of dough through apparatus 10, and the operation of the various system components, are in a timed relationship that is under the control of circuit 100 shown in FIG. 11. In the system, the processing of a batch of dough from mixer 8 is completed within a predetermined time period so that last individual packet IP of the batch being processed and a first individual packet of this same batch have the same uniform density and uniform texture within a pre-established variation range. Typically, the entire batch is converted into individual packets IP of conditioned dough corresponding to the predetermined number of bread loaves to be produced from the batch. Packets IP are deposited individually in cavities C of pans P within 10-20 minutes after mixing ingredients that make the batch.

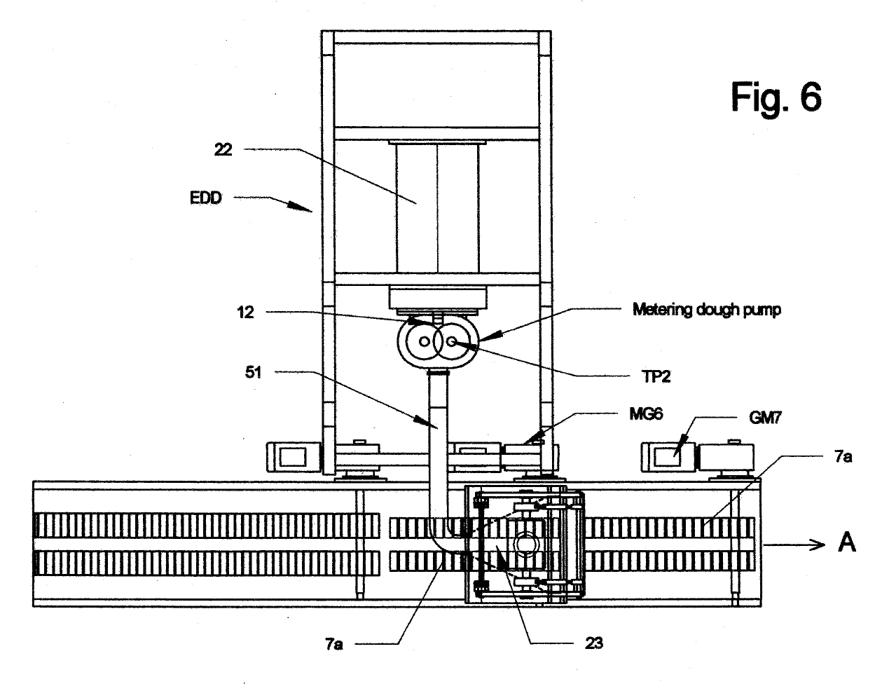

Extrusion dough divider unit 11 extrudes the conditioned dough into a dough stream DS (FIGS. 5, 8A, 10A-10C), and is built with dual auger dough feeder 29 (FIGS. 4) driven by gear motor GM3. Control dough pressure sensor 12 (FIGS. 3, 5) is at discharge end E10 (FIG. 5) of extrusion dough divider unit 11. The speed of the extrusion dough divider's drive gear motor GM3 is controlled by program 101 for microprocessor MP in response to the pressure detected by pressure sensor 12 and the command of the recipe speeds set values at the HMI. For the purpose of achieving a constant density before the dough is directed to an intake of second transfer metering dough pump TP2 (FIGS. 4, 5 and 6), this pump meters the conditioned dough from dough divider dual auger 29 to die manifold member 23, which includes extrusion port EP from which the dough stream exudes. Control circuit 100 shown in FIG. 11 includes means for operating transfer pumps TP1 and TP2 at predetermined regulated speeds. Control circuit 100 includes pressure sensor 12 (FIGS. 5, 6) that detects the pressure of dough stream DS exiting extrusion divider unit 11 and microprocessor MP with program 101 to operate speed controls as a function of the detected pressure commanded by the process recipes at human-machine interface HMI.

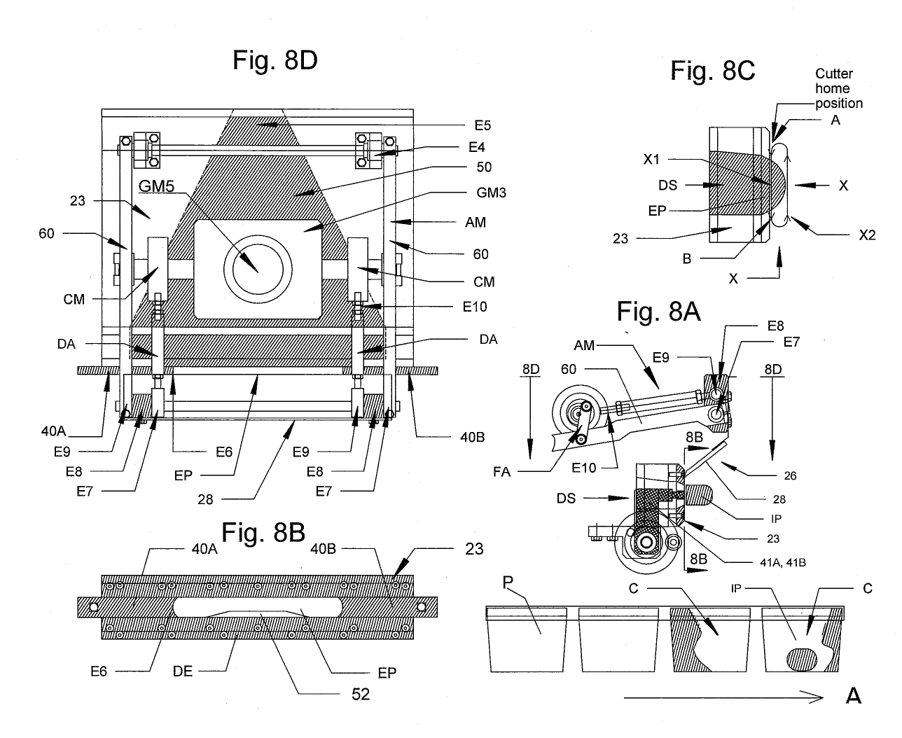

The conditioned dough from dough developer unit DD is delivered to extrusion dough divider hopper 11, and extrusion dough divider unit 11 extrudes the dough-through extrusion port EP (FIG. 8B) as a constant solid, wide flat dough stream DS of conditioned dough at a controlled volumetric feed rate and at a controlled pressure. In accordance with the process, cutter 26 immediately cuts the dough stream DS into individual dough packets IP that drop, due to gravity, directly into individual cavity C in pan P moving past the cutter. As best shown in FIG. 4, a pair of endless belt, pan feeder conveyors 7a (FIGS. 4, 5, 6) aligned along path A are spaced apart to provide gap G directly beneath extrusion port EP of die manifold member 23. As a batch of dough mix is processed, pans P continuously move in a step-wise fashion along predetermined path A and receive individual dough packet IP therein that drops into a pan directly below extrusion port EP. When the processing of one batch of dough mix is completed, apparatus 10 is cleaned whenever a batch of a different recipe is to be processed by the apparatus. When cleaning apparatus 10, no pans P are covering or blocking gap G. Consequently, gap G is open between pan feeder conveyors 7a. As apparatus 10 is flushed out with water, waste matter flowing out the extrusion port during cleaning flows from extrusion port EP and passes through gap G between pan feeder conveyors 7a.

As best shown in FIG. 8A, extrusion dough divider unit 11 includes cutter 26 that in a continuously cyclical manner cuts dough stream DS into individual packets IP (FIGS. 8A, 9, 10B). Dough developer unit DD is above extrusion dough divider unit 11 and feeds the conditioned dough into hopper 53 of extrusion dough divider unit 11. Extrusion dough divider unit 11 has pipe 51 (FIG. 6) that delivers directly and continuously dough stream DS to the cutter 26.

Cutter 26 (FIGS. 8A, 9, 10A, 10B, 10C) includes pivotally mounted, arm mechanism AM driven by gear motor GM5 that moves knife blade 28 through predetermined path X (FIG. 8C) that clears the dough divider's extrusion port EP in a manner to avoid interfering with dough stream DS exiting extrusion port EP. Path X is depicted in FIG. 8C and comprises: Starting with tip 28a of blade 28 at home position A (FIG. 10A), arm mechanism AM includes pair of arms 60 that move the blade downward towards a portion of dough stream DS that has passed through extrusion port EP, severing this portion, which falls directly into cavity C of pan P. Tip 28a of blade 28 moves along downward vertical-linear segment X1 of the path X past extrusion port EP to point B (FIG. 10B), with tip 28a of blade 28 following linear segment X1 as it passes by extrusion port EP to arrive at point B, the end of the downward vertical-linear segment. As the next portion of dough stream DS exits extrusion port EP, tip 28a of blade 28 moves from point B away from the face of the die element of manifold member 23, and then along a substantially upward vertical-linear path, returning tip 28a of blade 28 to home position A without contacting the next portion of dough stream DS exiting the extrusion port.

As best shown in FIG. 8D, pair of arms 60 are mounted at ends E4 to pivot. Blade 28 is fixedly attached between pair of arms 60 to other ends E7 of arms 60. About midway along each arm 60 is follower arm FA interconnected to cam mechanism CM that actuates driver arm DA having one end E10 fixedly attached to the cam mechanism. There are a pair of driver arms DA and blade 28 is mounted between ends E9 of driver arms DA. Blade 28 is pivotally attached so it moves along path X as follower arm FA and cam mechanism CM interact. As cam 90 (FIGS. 10A-10C) of cam mechanism CM is rotated by cam mechanism's central drive shaft 62, on a down stroke initiated from home position A shown in FIG. 10A, tip 28a of blade 28 follows linear segment X1 of path X. On reaching position B shown in FIG. 10B, drive shaft 62 of cam mechanism CM initiates its upstroke, as shown in FIG. 10C, causing follower arm FA to begin lifting arm 60 upwards and raising tip 28a of blade 28. Simultaneously, tip 28a of blade 28 is moved away from the face of die element DE, by the action of driver arm DA pulling backward on end E9 of arm DA, to pivot this end at bearing points E7 of arms 60, attached to floating knife block support elements E8, and continuously pulls tip 28a away from the face of the die element DE, with the aid of the pivot point E7 at the end of arm 60, attached to floating knife support blocks E8, by pivot shaft on E7, and then moves the tip towards the face of die element DE as the cam mechanism continuously rotates until home position A is reached. Program 101 includes a sub-routine that operates gear motor GM5 at a faster rate of speed after severing dough stream DS, increasing the speed at which knife blade 28 returns to home position A. The cutting cycle is then again initiated.

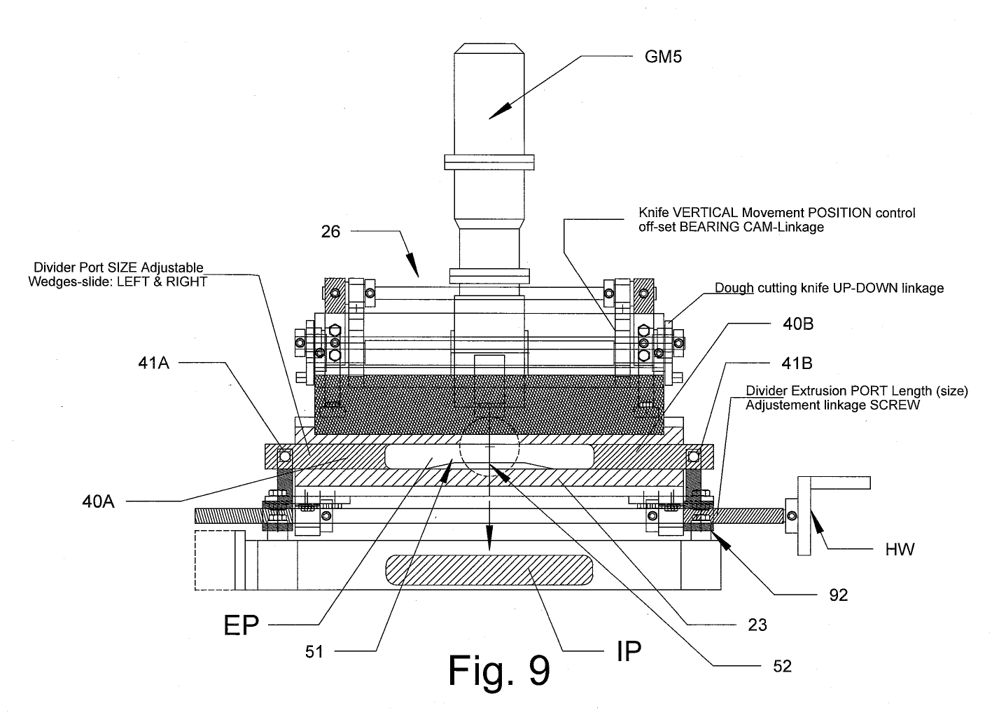

As best shown in FIGS. 8B and 8D, extrusion port EP is at a terminal end of chamber 50 in die element DE. Chamber 50 has entry end E5 and extrusion port EP is at end E6 opposed the entry end. Chamber 50 has a generally flat top and bottom and outward sloping sides to form a generally shaped triangle configuration. Extrusion port EP has a generally rectangular shaped open window that has an adjustable open area that allows the shape of the extrusion port to be laterally expanded or reduced. To achieve this each side of extrusion port EP includes a pair of spaced apart, adjustment wedge-slides 40A, 40B (FIGS. 8B, 9). Each wedge-slide 40A and 40B has a semi-circle shape cut out on the inner end thereof facing chamber 50. The adjustment of wedge-slides 40A and 40B in and outwards on each side of the window opening by repositioning the slides changes the weight of the product being processed at the time. The center of the extrusion port may have narrowing feature 52 that may provide better distribution of the dough packet into the pan. An individual, single, packet IP has a generally cylindrical configuration, typically a diameter from 1¼ to 2½ inch and a length from 8 to 16 inch. This size and configuration of packet IP is suitable upon baking to make one bread loaf, which is removed from pan's cavity C (FIG. 8A) in which the loaf was baked. As shown in FIG. 9, manually actuated adjustment mechanism 92 (FIG. 9) with hand-operated wheel HW mechanically linked to wedge-slides 40A and 40B enables the slides to be move towards and away from a center of extrusion port EP.

### Operation

In the embodiment where a constant uniform density and uniform texture of the dough is automatically controlled, every time a new batch of unconditioned dough is dumped into first transfer pump TP1, a mixer generated time (true) signal is sent as an input to programmable logic controller (PLC) at human-machine interface (HMI) shown in FIG. 11. Program 101 of programmable logic controller PLC starts a new sequential sub-routine upon receiving this time signal that:

1. Controls the speeds of developer blade gear motor drive GM5 in an incremental timed sequence of a dough batch process time, slower when the dough batch is fresh and faster as the dough batch ages. After every dough batch process time, the programmable logic controller PLC is monitoring the time signal repeatedly automatically, without the aid of an operator to start a new sequential sub-routine. This sequential sub-routine controls the speeds of developer blade gear motor drive GM2 to maintain a uniform density and texture (conditioning) of each dough batch through its entire process time period (typically from 10 to 20 minutes) in small incremental speed sequential control, as best predetermined by the process requirements.

2. Controls the speed of second transfer pump TP2, divider metering dough pump gear motor GM3 in an incremental timed sequence of a dough batch process time, (slower when the dough batch is fresh and faster as the dough ages). After every dough batch process time, programmable logic controller PLC is monitoring the time signal repeatedly automatically, without the aid of a human operator to start a new sequential routine. This sequential sub-routine controls the speed of second transfer pump TP2, metering dough pump gear motor GM4 to maintain a consistent volumetric dough flow to die manifold member 23 for achieving a consistent scaling weight of each dough packet IP being cut in small incremental speed sequential control, as best predetermined by the process requirements.

Transfer dough pump motor GM1 starts to run on a demand signal created by a level sensor electronic eye DDE at the dough hopper if the eye signals a low level. First transfer pump TP1 starts to supply unconditioned dough to dough developer unit DD until dough hopper 53 is filled to its highest level. Electronic eye DDE monitors the dough levels low and high at the dough hopper 53, and as the dough level sensor is satisfied (high level) gear motor GM2 variable speed drives can be started by programmable logic controller PLC, provided all safety and other support systems are ready.

Level sensor electronic eye EDDE monitors the dough levels low and high at dough hopper 53, and as the dough level sensor is satisfied (high level) the dual auger, variable speed gear motor GM3 can be started by programmable logic controller PLC, provided all safety and other support systems are ready. Gear motor GM3 operates extrusion dough divider unit EDD to feed the dough as a continuous evenly pressurized dough stream DS. Pressure sensor 12 continuously monitors dough stream DS to confirm it satisfies the pressure value preset in the recipe for the type of bread loaf being made. Dough stream DS is fed directly into the intake of second transfer pump TP2. Pump TP2 is a metering dough pump with variable speed gear motor drive GM6. The speed and volumetric capacity controls the volumetric rate of the dough being extruded through the die manifold member 23. Arm mechanism AM is driven by servo motor GMS, which has speed cycles that are set in the recipe, the cycle rate being set to match the cuts/minute of the process, and to deliver the dough packets in a timed manner into empty pan cavity C.

3. The steps to start and run apparatus 10 are as follows:
a. The operator selects a recipe number at human-machine interface HMI.
b. The operator makes any temporary recipe speed adjustment values.
c. When electronic eye DDE is satisfied, the system will be able to start, by pressing a start button at human-machine interface HMI.
d. Dough developer gear motor GM2 starts to run to the speeds preset for the recipe for the type of bread loaf to be processed, auger dough feeder 20 moves the dough into developer blade 21 driven by GM2, discharging the dough into dough hopper 53 of extrusion dough unit 11 until the electronic eye senses that the dough level is satisfied. Variable speed gear motor drive GM3 starts running dual auger 29, feeding and pressurizing the dough to satisfy the preset pressure value in the recipe. As shown in FIG. 5, pressure sensor 12 continually monitors pressure at outlet end E11 of extrusion dough unit 11 before pressurized dough stream DS is fed into intake end E12 of second transfer pump TP2, which pushes a metered amount of the dough through die manifold member 23 at a predetermined volume rate. Each newly cut dough packet falls into each empty pan cavity C, pan feed conveyors 7a are cyclically controlled by a timing signal (clock) created in programmable logic controller PLC, which in turn controls the cyclical sequence of knife blade 28 and the pair of pan conveyors 7a in a synchronous sequential speed rate. This completes the running cycle of the process.
e. When electronic eye DDE senses a low-level condition, it demands more dough supply from first transfer pump TP1.
f. When the other electronic eye EDDE dough senses a low-level condition, it demands more dough supply from dough developer unit DD.
g. These conditions described on steps c, d, e, f, g above, are continuous repetitious cycles throughout the duration of each batch of dough processed through apparatus 10.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

The above presents a description of the best mode of carrying out the apparatus, system and process, and of the manner and process of making and using them, in such full, clear, concise, and exact terms as to enable a person skilled in the art to make and use. The apparatus, system and process are, however, susceptible to modifications and alternate constructions from the illustrative embodiment discussed above which are fully equivalent. Consequently, it is not the intention to limit the apparatus, system and process to the particular embodiment disclosed. On the contrary, the intention is to cover all modifications and alternate constructions coming within the spirit and scope of the apparatus, system and process as generally expressed by the following claims, which particularly point out and distinctly claim the subject matter of the present disclosure.

1. A system for making a bakery product comprising:
means for continuously moving pans along a predetermined path;
means for directly and continuously feeding unconditioned dough into means for conditioning the unconditioned dough that reduces the size of air pockets within the unconditioned dough to provide a conditioned dough; and
means for directly and continuously feeding the conditioned dough at a controlled volumetric feed rate and at a controlled pressure to means for continuously extruding the conditioned dough into a single dough stream that is fed directly and continuously into means for continuously cutting the extruded dough stream into individual packets,
wherein the moving means, the extruding means and the cutting means are positioned relative to each other so that, upon cutting the dough stream, the individual packets each drop directly into an individual cavity of a pan moving along the predetermined path.

2. The system of claim 1 further comprising:
means for mixing ingredients to make a batch of bread dough, wherein upon mixing, the ingredients produce the unconditioned dough and the batch provides a predetermined number of bread loaves.

3. The system of claim 2, wherein the system converts the batch into individual packets of conditioned dough corresponding to the predetermined number of bread loaves to be produced.

4. The system of claim 1, further comprising:
a control circuit means for operating speed controls of auger-developed blade means in the means for conditioning the unconditioned dough and auger means in the means feeding the conditioned dough to the extruding means.

5. The system of claim 4, wherein the control circuit means includes a pressure sensor that detects the pressure of the single dough stream exiting the extruding means and a microprocessor programmed to operate the speed controls as a function of the pressure.

6. A method of making a bread loaf, the method comprising:
(a) continuously conditioning a batch of unconditioned dough to reduce the size of air pockets within the unconditioned dough to produce a batch of conditioned dough;
(b) continuously extruding the batch of conditioned dough at a controlled volumetric feed rate and at a controlled pressure to provide a constant stream of conditioned dough; and
(c) continuously cutting the constant stream of conditioned dough into individual packets, wherein each individual packet is directly deposited in an individual cavity of a pan moving along a predetermined path without additional processing of the conditioned dough prior to deposition in the individual cavity.

7. The method of claim 6, wherein the constant stream of conditioned dough makes a predetermined number of individual packets, and wherein the last individual packet deposited and a first individual packet deposited have the same uniform density and uniform texture.

8. The method of claim 6, wherein the individual packets of conditioned dough correspond to the predetermined number of bread loaves to be produced.

9. The method of claim 6, wherein, upon formation of an individual packet, the individual packet drops due to gravity directly into the individual cavity of the pan without further processing of the individual packet after cutting the constant dough stream.

10. The method of claim 6, wherein the constant dough stream is processed without the use of flour to treat the individual packets.

11. An apparatus for making bread loaves comprising:
a mixer in which ingredients to make a batch of bread dough are mixed to produce an unconditioned dough having enlarged and different sized air pockets, said batch providing a predetermined number of bread loaves;
a pan feeder that continuously moves baking pans in a stepwise manner along a predetermined linear path, each pan having at least one empty cavity sized and configured to bake a single bread loaf;
a dough developer unit above said predetermined linear path that reduces the size of air pockets within unconditioned dough, so that dough exiting the developer unit is conditioned;
a first transfer pump that continuously feeds the unconditioned dough from the mixer to the dough developer unit;
an extrusion unit below the dough developer unit and above the predetermined linear path that continuously extrudes the conditioned dough into a single dough stream;
a second transfer pump that continuously meters the conditioned dough from the extrusion unit through an extrusion port of a die manifold member of the extrusion unit, wherein the extrusion port is narrower in a center part relative to the sides of the extrusion port; and
a cutter unit above the predetermined linear path that continuously cuts the single dough stream into individual packets, wherein each of the individual packets is deposited in an individual cavity in a pan moving along said predetermined path, wherein the extrusion port is positioned relative to the predetermined linear path such that upon cutting the single dough stream, each of the individual packets drops directly into a cavity of a pan positioned directly beneath the extrusion port; and
a control system that delivers the single dough stream to the cutter unit at a controlled volumetric feed rate and at a controlled pressure.

12. The apparatus of claim 11, wherein the cutter unit includes a blade that moves through a predetermined path from a home position above the single dough stream, along the face of the die manifold member past the extrusion port to sever the single dough stream, and then away from the face of the die manifold in a manner to avoid interfering with the single dough stream continuing to exit the extrusion port.

13. The apparatus of claim 11, where the extrusion port has a rectangular shape with opposed sides, each opposed side comprising a laterally adjustable wedge-shaped slide element to enable a width of the extrusion port to be increased or decreased.

14. The apparatus of claim 12, where the blade that is moved from a home position above the single dough stream along a downward vertical-linear path at a first rate of speed and, after moving away from the face of the die manifold, is moved at an increased rate of speed to the home position at least in part along an upward vertical-linear path.

15. The apparatus of claim 11, wherein the die manifold member includes a chamber having a generally flat top and flat bottom and outward sloping sides to form a generally shaped triangle configuration with an entry end at an apex of the triangular configuration and the extrusion port forming the base of the triangular configuration.

16. The apparatus of claim 11, wherein the pan feeder includes a pair of aligned pan conveyors along said predetermined path along which the pans move that are spaced apart to provide a gap beneath the extrusion port to facilitate flushing waste matter from the apparatus during cleaning.

17. The apparatus of claim 11, wherein the control system includes a monitoring element that senses the amount of conditioned dough being produced and, in response, regulates operation of the dough developer unit.
